(19) United States
(12) Patent Application Publication
(10) Pub. No.: US 2026/0257721 A1
(43) Pub. Date: Sep. 3, 2026

(54) SYSTEM ARCHITECTURE FOR FUNCTIONAL SAFETY IN AN ACTIVE STEER-BY-WIRE SYSTEM

(71) Applicant: LORD Corporation, Cleveland, OH (US)

(72) Inventors: Anirban Chaudhuri, Cary, NC (US); Abraham Matthew, Cary, NC (US); Jeffrey Cranmer, Raleigh, NC (US)

(73) Assignee: LORD Corporation, Cleveland, OH (US)

(21) Appl. No.: 19/162,253

(22) PCT Filed: Mar. 14, 2023
(86) PCT No.: PCT/US2023/015202

§ 371 Date: Sep. 4, 2025

(51) Int. Cl. B62D 6/00; B62D 5/00; B62D 15/02

(52) U.S. Cl. CPC B62D 6/008; B62D 5/006; B62D 15/0215

(57) ABSTRACT

Disclosed is a force feedback system for use in steer-by-wire vehicles. The force feedback system provides active tactile feedback to the vehicle operator and provides safety control over the steer-by-wire vehicle. Also disclosed is a method of providing safe return of the steering control system of a steer-by-wire vehicle to a center position.

### BACKGROUND

In traditional vehicle steering systems, the steering system includes mechanical arrangements such as positive caster to force the steering wheel back to center (zero road wheel angle) position whenever the operator steers away. The effect provided by the positive caster configuration is compounded at higher vehicle speeds. Thus, the mechanical arrangement of positive caster increases vehicle stability and provides good on-center feel. Current steer-by-wire systems lack the necessary steering linkage to provide active operator feedback and return to center functionality of traditional steering systems.

A steer-by-wire input device with active tactile feedback must provide an acceptable level of functional safety by providing accurate angular position sensing and preventing uncommanded motion of the steering input shaft and uncommanded tactile feedback.

The exemplary embodiments disclosed herein overcome the shortcomings of current steer-by-wire systems and adds functional safety to the overall system. As a further benefit, the disclosed embodiments can be incorporated into current steer-by-wire systems found on land and marine vehicles.

### SUMMARY

Disclosed is a force feedback system. The force feedback system includes a steering shaft; a Hall sensor magnet carried by the steering shaft; an electrically controlled brake configured to engage the steering shaft; an electronically controlled motor configured to engage the steering shaft; at least one electrical power source; a brake drive amplifier; motor drive amplifier. The brake drive amplifier receives electrical power from the at least one electrical power source and the brake drive amplifier provides electrical current to the electronically controlled brake. The force feedback system further includes motor drive amplifier, the motor drive amplifier receives electrical power from the at least one electrical power source and the motor drive amplifier provides electrical current to the electronically controlled motor. Additionally, the force feedback system includes a first pair of angular position sensors and a steering input controller. The first pair of angular position sensors receive electrical power from the at least one electrical power source. The vehicle controller is in data communication with the first pair of angular position sensors and the steering input controller. The force feedback system may include a second pair of angular position sensors as well as a second and a third electrical power source. Additionally, the force feedback system may include a main microcontroller and a safety or backup microcontroller.

Further this disclosure provides a method for returning a steering control system of a vehicle to a center position. The method includes the steps of:
the vehicle having at least one steering wheel, the steering wheel capable of adjusting the steering control system through a range of angular orientations including the center position of the steering control system;
the steering control system including an electric motor and a steering input controller, the steering input controller directly or indirectly controls the angle of the wheel by controlling operation of the electric motor,
the steering control system including a force feedback device, the force feedback device in data communication with the vehicle steering controller, the force feedback device including at least one angular position sensor, an electric motor, an electrically actuated brake, and a microcontroller;
transmitting data provided by the at least one angular position sensor to the vehicle controller;
transmitting data from the road wheel angle sensor, the vehicle speed sensor, to the vehicle controller;
the vehicle controller analyzing the data received to detect a fault in any one of the at least one angular position sensor;
the microcontroller initiating a closed loop operation to produce a change in the angular orientation of the wheel;
the microcontroller defining a value for a Target Parameter using data received by the microcontroller wherein a value of zero corresponds to the center position of the steering control of the vehicle;
the microcontroller managing the operation of the force feedback device to drive the Target Parameter to a value of zero by controlling the operation of the electric motor.

### BRIEF DESCRIPTION OF THE DRAWINGS

FIG. 1 provides an exemplary embodiment of system architecture for improving the safe operation of a steer-by-wire system.

FIG. 2 provides a block diagram of the elements of a force feedback device (FFD) suitable for use in the exemplary embodiments of FIG. 1.

FIGS. 3A and 3B provides a control flow diagram of the operations for management and safe operation of the electric motor component of the FFD.

FIGS. 4A and 4B provide a process flow diagram for the safety loop which provides for safe operation of the electrically controlled motor identified in FIGS. 2 and 7.

FIGS. 5A and 5B provide a process flow diagram for the safety loop which provides safe operation of the electrically controlled brake identified in FIGS. 2 and 7.

FIG. 6 provides another exemplary embodiment of system architecture for improving the safe operation of a steer-by-wire system.

FIG. 7 provides a block diagram of the elements of a force feedback device (FFD) suitable for use in the exemplary embodiments of FIG. 6.

FIG. 8. provides a control flow diagram of the operations for management and safe operation of the electrically actuated brake component of the FFD.

### DETAILED DESCRIPTION

The drawings included with this application illustrate certain aspects of the embodiments described herein. However, the drawings should not be viewed as exclusive embodiments. The subject matter disclosed is capable of considerable modifications, alterations, combinations, and equivalents in form and function, as will occur to those skilled in the art with the benefit of this disclosure.

The present disclosure may be understood more readily by reference to these detailed descriptions. For simplicity and clarity of illustration, where appropriate, reference numerals may be repeated among the different figures to indicate corresponding or analogous elements. The following description is not to be considered as limiting the scope of the embodiments described herein. The drawings are not necessarily to scale and the proportions of certain parts may have been exaggerated to better illustrate details and features of the present disclosure. Also, the phraseology and terminology employed herein is for the purpose of description and should not be regarded as limiting except where indicated as such.

Throughout this disclosure, the terms “about”, “approximate”, and variations thereof, are used to indicate that a value includes the inherent variation or error for the device, system, or measuring method being employed as recognized by those skilled in the art.

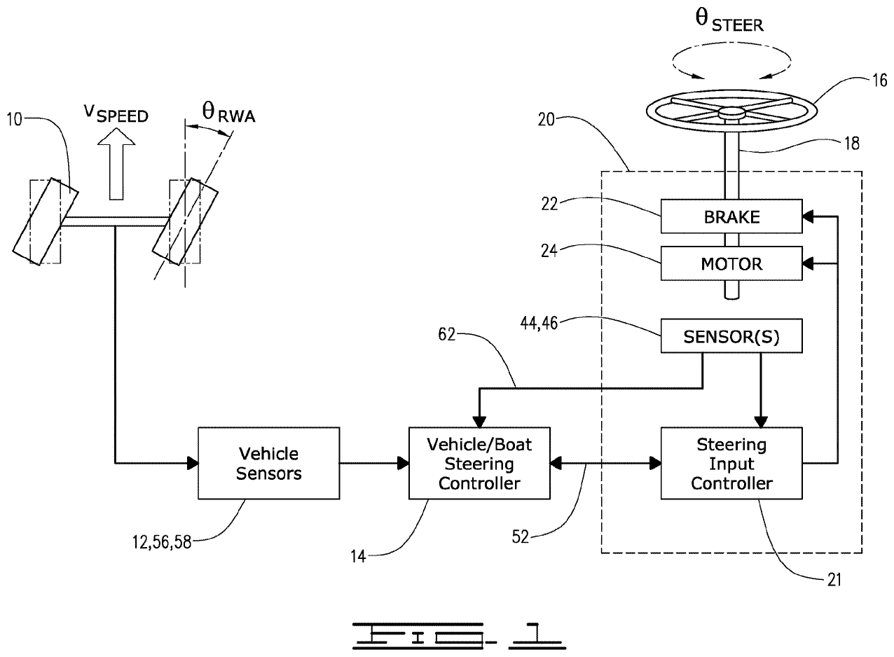

FIGS. 1-2 and 6-7 provide exemplary embodiments of an improved force feedback system. The force feedback system may be incorporated into existing steer-by-wire systems found on land and marine vehicles. The force feedback system produces active feel or feedback to the vehicle operator based on the state of the vehicle and incorporation of a target parameter as explained in detail below. Additionally, the force feedback system provides separation of functional safety tasks between a force feedback device 20 and the vehicle's original system.

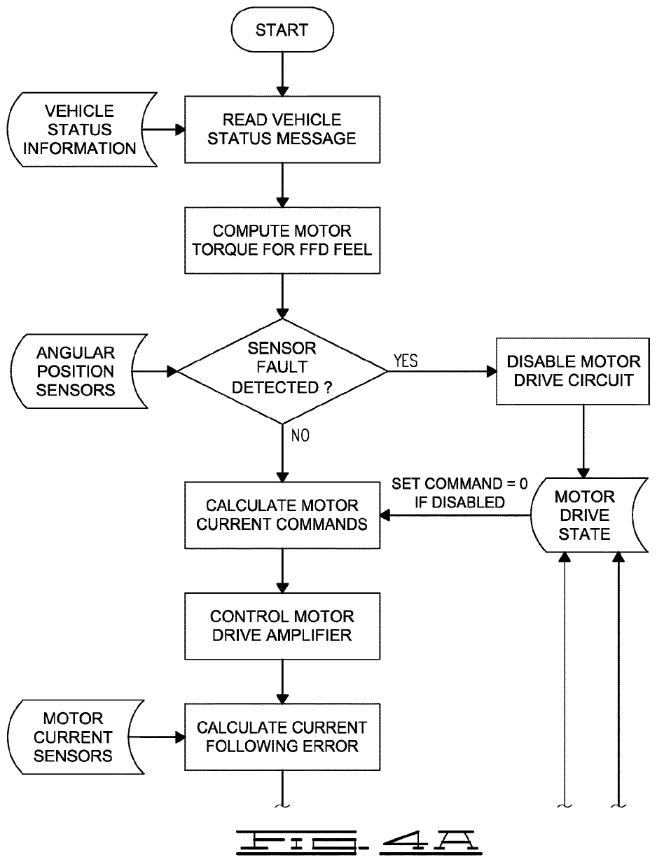

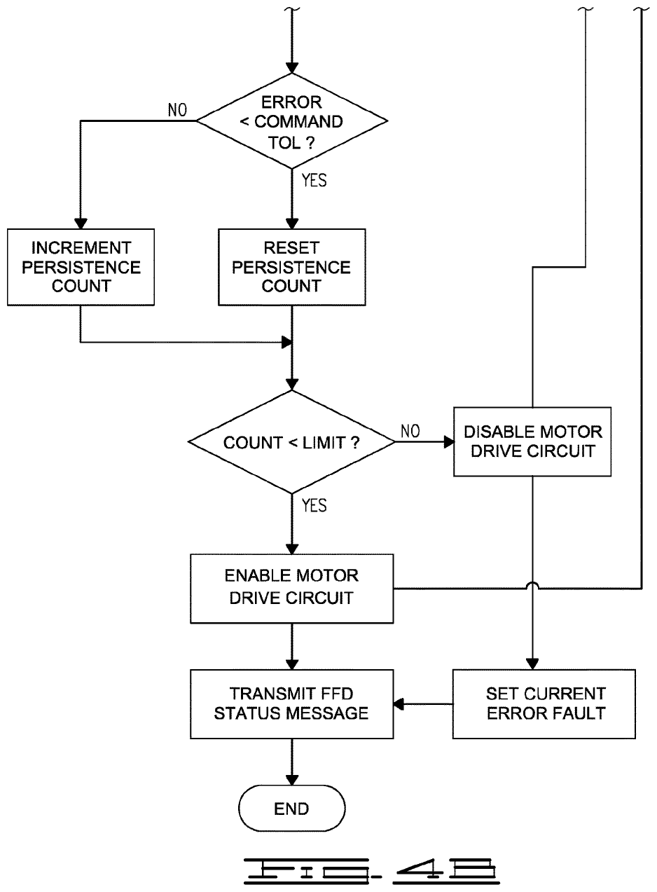

Each embodiment includes a force feedback device 20 suitable for returning a directional control element e.g. a steering wheel 16 or control wheel 16, to center using a combination of an electric motor 24 and an electrically operated brake 22 mounted in-line with a steering shaft 18 which supports steering wheel 16. As will be described in greater detail below, for the purposes of the operation of the vehicle, center can be defined by any number of vehicle parameters. Force feedback device (FFD) 20 will utilize one or more angular position sensor pairs 44, 46 to measure a current position of steering wheel 16 and also read the current state of the vehicle over the CAN bus 52. For conciseness, the remainder of this disclosure will refer to CAN bus 52; however, any suitable digital communication bus will suffice. Microcontroller 50 uses this information to control electric motor 24 to apply sufficient torque to return steering shaft 18 and steering wheel 16 to the defined center location and/or brake 22 to apply sufficient torque to provide tactile feedback to the operator. To enhance safe operations of the vehicle, the exemplary system architectures perform three primary tasks: (i) transmission of accurate angular position information and diagnostics to the vehicle (either directly or indirectly), (ii) prevention of uncommanded motion of the motor, and (iii) prevention of steering lock due to uncommanded current in the coil of the electric brake. Further, the exemplary system architectures provide for separation of safety tasks between a steering input controller and a vehicle steering controller. Thus, while continuously implementing the feel algorithms used to drive the Target Parameter to zero, microcontroller 50 also monitors angular position sensors 44, 46, brake drive amplifier 38, and motor drive amplifier 42. One example of a suitable algorithm is provided in FIGS. 4A and 4B. For the purposes of the remainder of this disclosure, returning of steering shaft 18 to center will be referred to as returning to a Target Parameter. Thus, in mathematical terms, the return of steering shaft 18 to center equates to forcing the Target Parameter to zero.

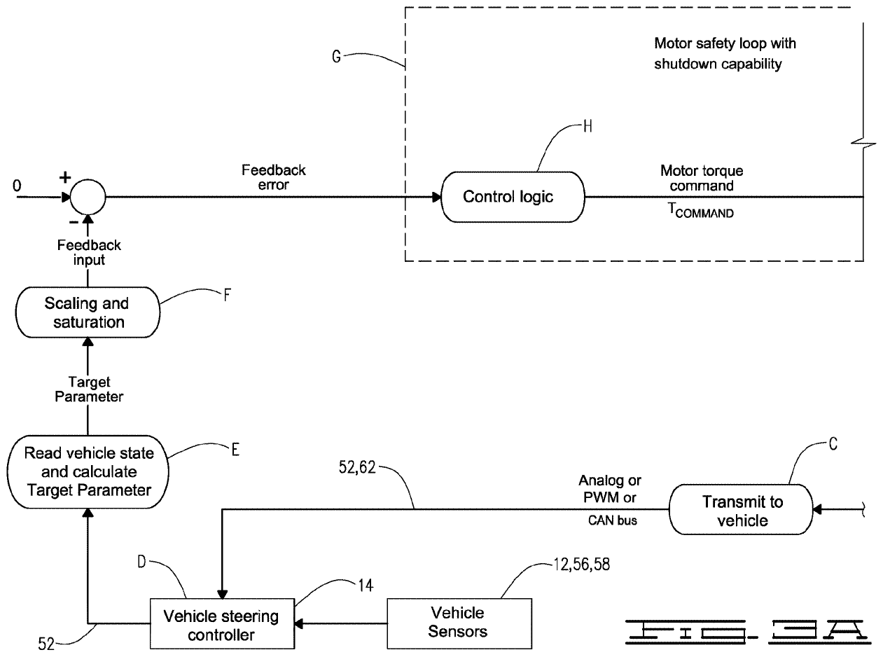

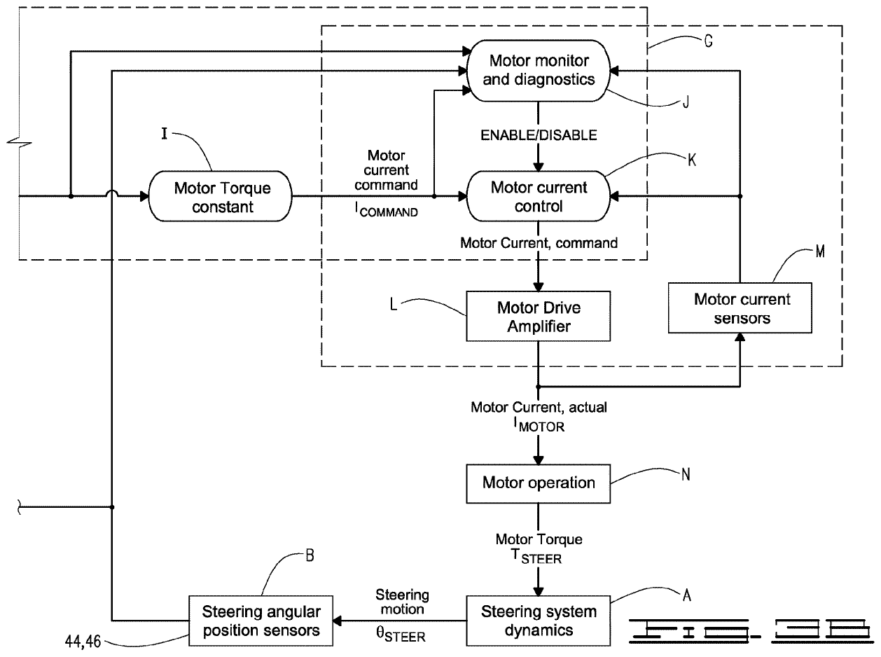

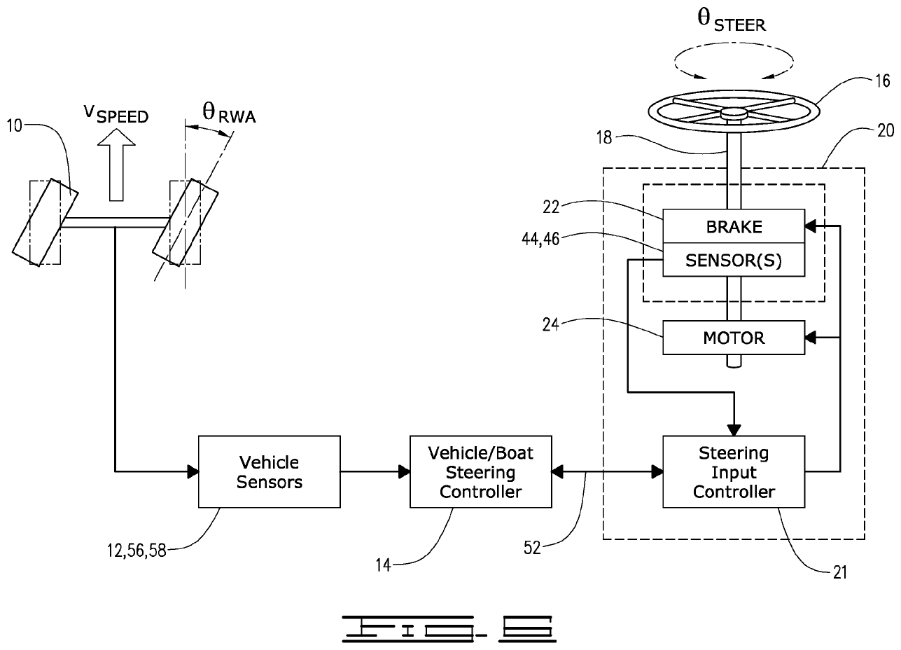

Prior to discussing the two exemplary embodiments described herein, the following definitions will be helpful in understanding the terminology in the process flow diagrams of FIGS. 3-5.
Motor torque control logic
   Includes different types of closed loop feedback control schemes e.g. proportional control (P), proportional integral (PI), proportional-integral-derivative (PID) or other similar method suitable for closed feedback control.
   Output is the desired motor torque (TCOMMAND, FIG. 3A).
Motor torque constant
   To calculate the motor winding current (ICOMMAND, FIG. 3B) needed to produce the desired motor torque
   Usually provided by the motor manufacturer
Motor current control
   Operation to control motor winding amplifiers and drive the necessary currents (IMOTOR, FIG. 3B) through windings based on shaft position, also referred to as “motor commutation”
   E.g., trapezoidal control, sinusoidal control, field-oriented control
Motor operation
   Production of torque (TSTEER, FIG. 3B) due to current in the motor windings.
Steering Angular Position Sensors
   Angular position sensors 44, 46 used to measure the angular position (θSTEER) of steering shaft 18.
Steering system dynamics
   Movement of the steering shaft 18 due to torque generated (TSTEER) by the electrically controlled motor 24.
   Torque generated overcomes steering shaft 18 and wheel 16 inertia and friction forces, and produces rotational motion of the steering wheel 16 mounted on steering shaft 18.
Scaling and saturation
   Mathematical operations done by the microcontroller(s) 50, 50a, 50b running the control logic based on information received from the vehicle steering controller 14 to calculate the Target Parameter and produce desired behavior of steering system (e.g. response time).
Vehicle steering controller 14
   In the exemplary embodiments of FIGS. 1 and 6, reads original equipment vehicle sensors, which comprises a Road Wheel Angle (RWA) sensor 12 (sensor 12 provides road wheel or rudder angle θRWA), and communicates with FFD 20 microcontroller(s) 50a, b.

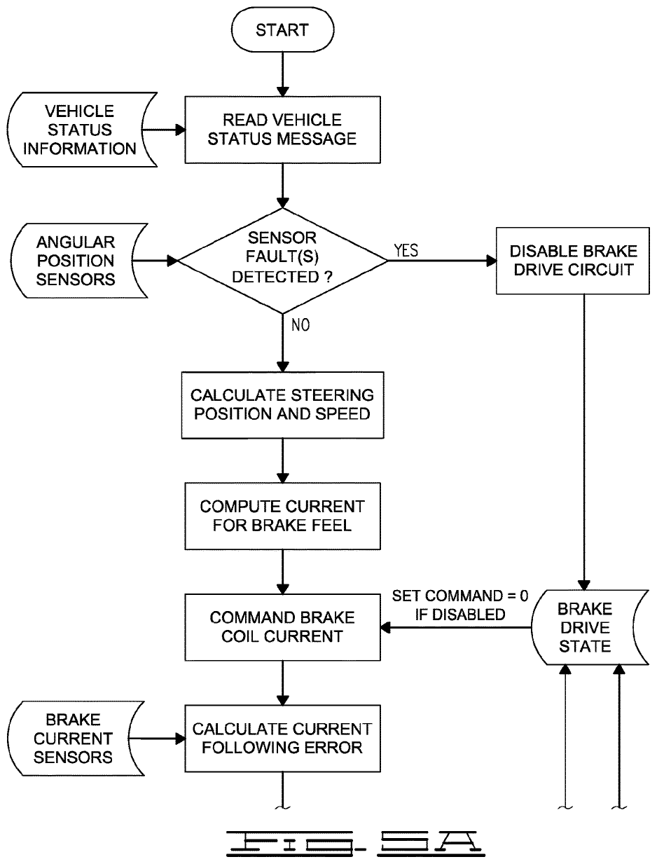

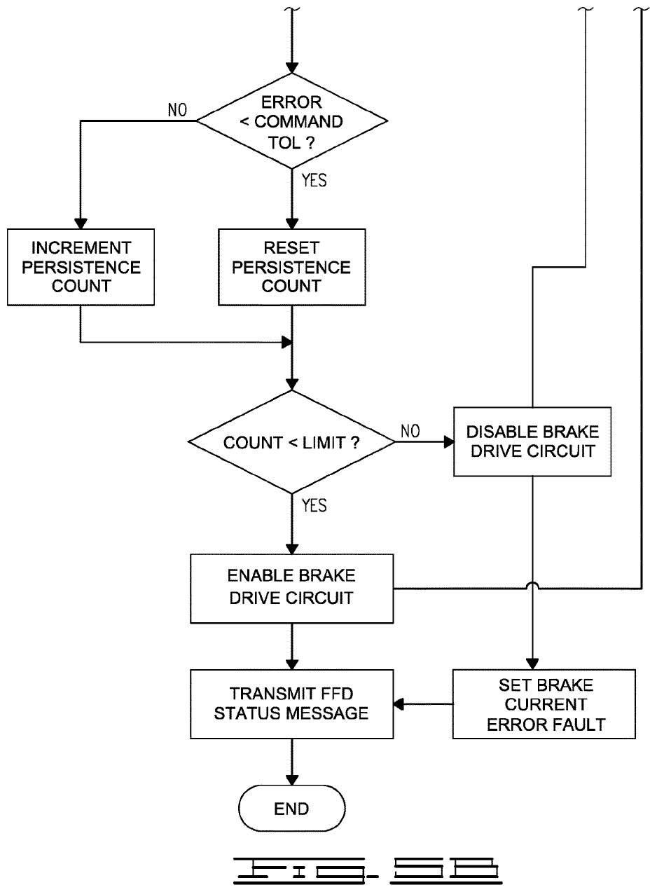

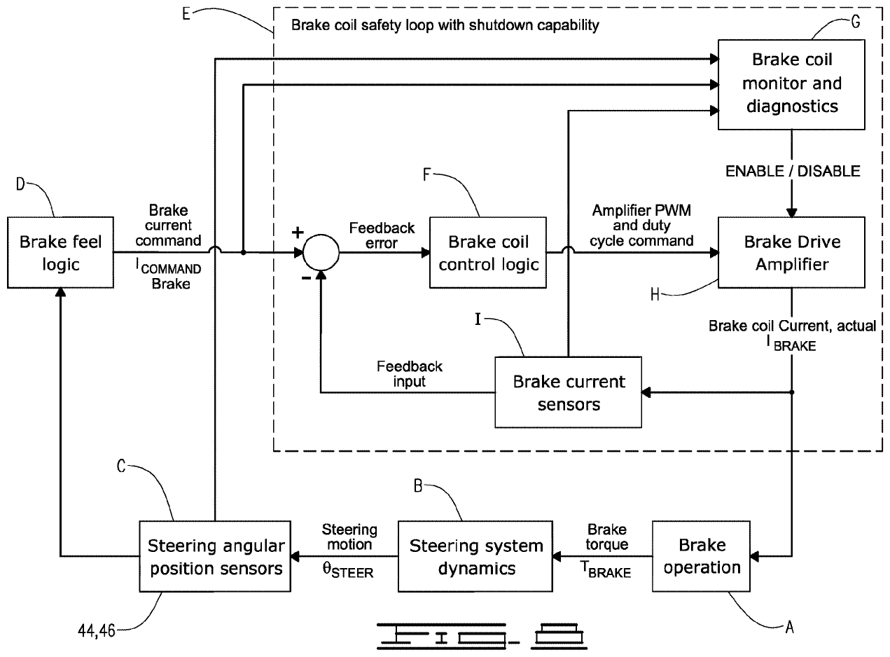

The following definitions will be helpful in understanding the terminology in the process flow diagrams of FIG. 8.
Brake operation
   Production of braking torque (TBRAKE) due to flow of brake coil current (IBRAKE) through the brake coil.
Brake feel logic
   Consists of algorithms that use measurement of steering angular position to calculate the required tactile feel (e.g. end-stop feel, steering velocity proportional feel etc.).
   Output is a commanded brake current (ICOMMAND,BRAKE)
   Examples of suitable algorithms are provided in FIGS. 5A, 5B and 8.
Brake current sensors
   Measure the actual current in the brake coil (IBRAKE)
Brake coil control logic
   Includes different types of closed loop feedback control schemes e.g. proportional control (P), proportional integral (PI), proportional-integral-derivative (PID) or other similar method suitable for closed feedback control
   Uses the brake command (ICOMMAND,BRAKE) and measured brake coil current (IBRAKE) to calculate duty cycle of PWM signal to drive brake coil current amplifier.
Brake coil current amplifier
   Includes circuitry that produces variable current through the brake coil based on input PWM command
Steering system dynamics
   Movement of steering wheel shaft 18 when braking torque is applied while an operator is trying to turn steering wheel 16.

FIGS. 1 and 6 provide exemplary embodiments of system architecture for improving the safe operation of a steer-by-wire system, FIG. 1 depicts directional control elements 10 of a land travelling vehicle, e.g. wheels, or in the case of a marine vessel rudders or other similar directional control mechanism. For simplicity, directional control elements 10 will be referred to as wheels 10 for the remainder of this disclosure. Wheels 10 correspond to the rudder of a marine vehicle. Associated with wheels 10 is at least one RWA sensor 12 suitable for monitoring the change in wheel angle (θRWA) for road vehicles or rudder angle position for marine vessels. Vehicle speed (VSPEED) is measured by a speed sensor 58. A vehicle steering controller 14 manages operation of the steer-by-wire system installed on the vehicle and receives data from RWA sensor 12 and vehicle speed sensor 58. Steering wheel 16, supported by steering shaft 18, provides steering input from the operator to the steer-by-wire system. In-line with steering shaft 18 is an FFD 20. FFD 20 includes an electrically controlled brake 22, an electrically controlled motor 24 and at least one angular position sensor 44, 46 configured to monitor the position of steering shaft 18. FFD 20 further includes a steering input controller 21 that controls the brake 22 and motor 24, and also exchanges information with vehicle steering controller 14 over a digital communication bus 52. An example of a suitable digital communication bus commonly found in vehicles is the CAN (Controller Area Network) bus.

As depicted in FIG. 1, brake 22, motor 24 and position sensors 44, 46 may be positioned within the same housing. Angular position sensor(s) 44, 46 may be any sensor suitable for monitoring rotational change of steering shaft 18; for example, non-contact Hall effect type sensors provide the ability to read the angular orientation of magnet 26 mounted to steering shaft 18. Angular position sensors 44, 46 optionally provide data directly to vehicle steering controller 14 via electrical bus 62 using analog, PWM or digital (e.g. SPI, SENT) signals.

FIG. 6 differs from FIG. 1 in that motor 24 is located outside of the housing containing brake 22 and sensors 44, 46. However, sensors 44, 46 are not necessarily mounted or secured to shaft 18. Rather, sensors 44, 46 are mounted in a position suitable for monitoring radial angular of magnet 26. Thus, FIG. 6 demonstrates that brake 22 and motor 24 may be arranged in alternative configurations relative to steering shaft 18 provided that brake 22 and motor 24 are connected to steering shaft 18 in a manner sufficient to impart torque and braking action necessary to achieve the desired torque feedback and return of steering shaft 18 based on the Target Parameter.

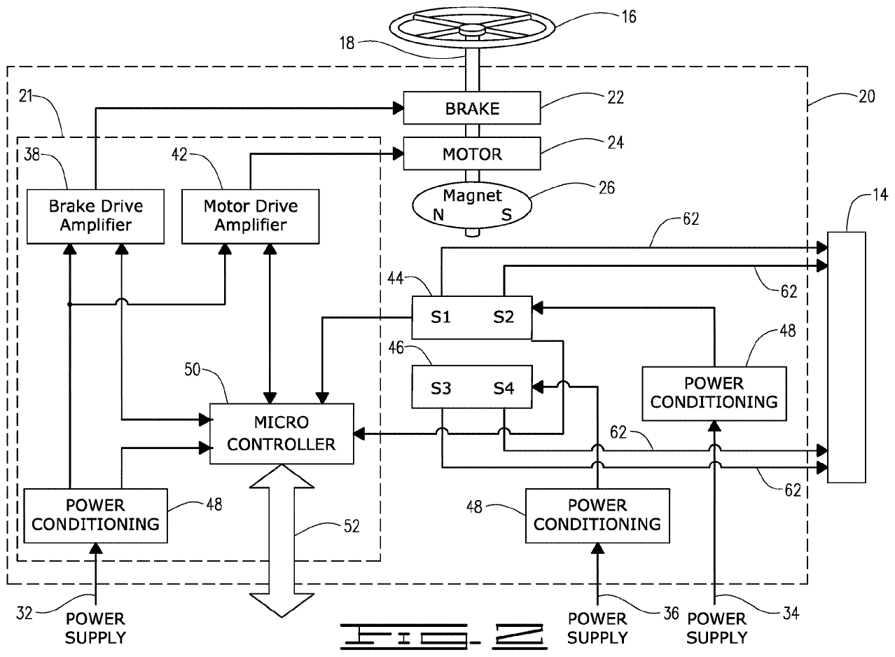

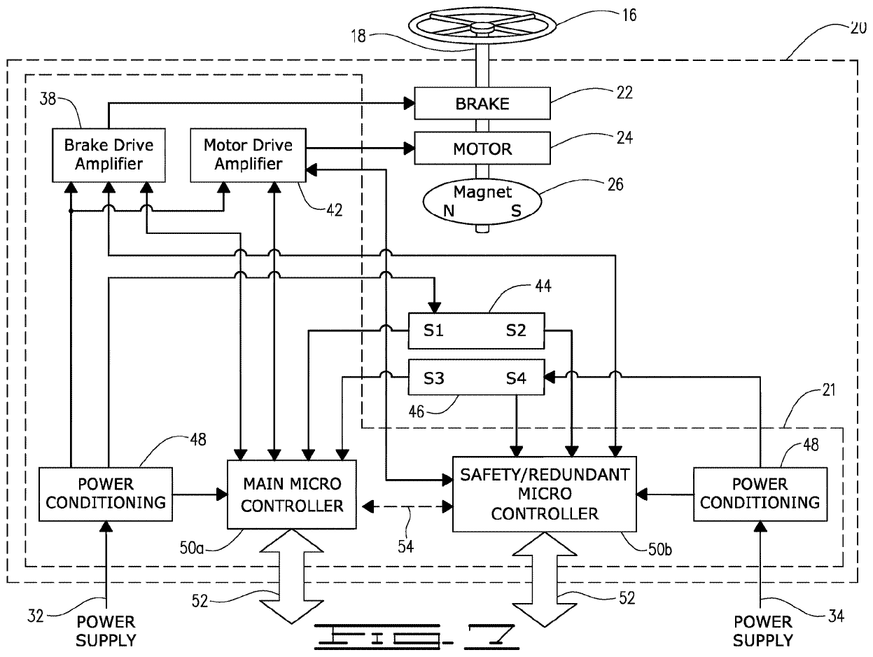

As depicted in FIGS. 2 and 7, angular position sensors 44, 46 provide angular position data of steering shaft 18 to microcontroller(s) 50, 50a, 50b. In FIG. 2, angular position sensor 44 consists of independent sensor pairs S1 and S2, while angular position sensor 46 consists of independent sensor pairs S3 and S4. As depicted in FIGS. 1 and 6, brake 22 and motor 24 are mounted in-line with and mechanically connected to steering wheel 16 by steering shaft 18. Additionally, when sensors 44, 46 take the form of a Hall type sensor, steering shaft 18 may carry a reference magnet 26 as a reference point for sensors 44, 46. As known to those skilled in the art, Hall effect sensors provide the ability to monitor rotational changes of a magnet by referencing the poles of the magnet.

As detailed in FIG. 2, one embodiment of FFD 20 has three power inputs 32, 34 and 36; however, in this embodiment the number of independent power inputs are not critical as a single power source will suffice for operation of FFD 20. Power input 32 provides electrical power to a brake drive amplifier 38, motor drive amplifier 42 and microcontroller 50. Brake drive amplifier 38 supplies current to electrically controlled brake 22, and motor drive amplifier 42 supplies electric current to electrically controlled motor 24. Power input 34 provides electrical power to a first pair of angular position sensors 44. Power input 36 provides electrical power to a second pair of angular position sensors 46. Optionally, electrical power from power inputs 32, 34 and 36 will pass through a power conditioning unit 48 to ensure a smooth continuous electrical current feed to each component while meeting industry mandated electrical power input requirements. The power conditioning units 48 will be selected to provide appropriate electrical current for the devices being powered. As depicted in FIG. 2, power input 32 receives battery current from the vehicles on board battery, e.g. a 12V or a 24V battery. Power inputs 34 and 36 may receive electrical power from vehicle steering controller 14, e.g. at 5V supply voltage level. However, other voltages can be used within the scope of this embodiment as determined by the units receiving the electrical current.

With continued reference to FIG. 2, FFD 20 includes magnet 26 carried by steering shaft 18, a first pair of angular position sensors 44 and an optional second pair of angular position sensors 46 configured to read the orientation of magnet 26. Additionally, FFD 20 includes at least one microcontroller 50 in data communication with a controller area network (CAN) 52. Microcontroller 50 receives electrical power from power input 32 via optional power conditioning unit 48. Microcontroller 50 is also in data communication with brake drive amplifier 38, motor drive amplifier 42 and first pair of angular sensors 44. In this embodiment of FIG. 2, during operation of the vehicle, first and second pairs of angular position sensors 44, 46 provide data to vehicle steering controller 14. Inter-functionality of the components will be described below.

The functionality of the exemplary embodiments will be described with reference to FIGS. 3-5 and 8. The exemplary embodiments disclosed herein function as closed loop systems to improve the safety of the vehicle's steer-by-wire system, not shown, associated with the system architecture. The disclosed systems provide controlled feedback to a vehicle operator and operate to return steering shaft 18 to a Target Parameter as defined by microcontroller 50. Typically, the Target Parameter will correspond to the center position of the steering control system. As used herein, the term center position corresponds to the neutral or straight-ahead position for the steering system. The computation of the Target Parameter by microcontroller 50 is based on information transmitted by the vehicle steering controller 14 over CAN bus 52. Information used to calculate Target Parameter may be any one or a combination of parameters like RWA, vehicle speed, and lateral acceleration. Motion of steering shaft 18 such that the Target Parameter returns to zero value will also result in the return of steering wheel 16 and wheels 10 to a center position. Additionally, microcontroller 50 manages operation of both electronically controlled brake 22 and electronically controlled motor 24 by controlling brake drive amplifier 38 and motor drive amplifier 42. Thus, microcontroller 50 prevents uncommanded operation of motor 24 and prevents steering lock-up due to uncommanded current in brake drive amplifier 38.

Sensors which provide vehicle RWA, vehicle linear speed and vehicle lateral acceleration, shown in FIG. 1, are well known to those in the art. These sensors are provided as part of the original equipment on the vehicle as is the vehicle steering controller 14. During operation of either a land or marine vehicle, sensor data from the linear speed sensors 58 is received by vehicle steering controller 14. Additionally, vehicle steering controller 14 receives data corresponding to any one or combination of road wheel angle (RWA) data from RWA sensor 12, vehicle speed (VSPEED) from vehicle speed sensor 58, and lateral acceleration from optional lateral acceleration sensor 56. Note that lateral acceleration may be computed by microcontroller 50 from other vehicle parameters transmitted by vehicle steering controller 14. Subsequently, vehicle steering controller 14 transmits the data over CAN 52 to microcontroller 50 of FFD 20. Note: for a marine vehicle, RWA corresponds to the rudder angle or the angle of another device which provides directional control to the marine vehicle, e.g. a nozzle on a jet ski. For the purposes of the remaining disclosure the description will simply refer to RWA.

Vehicle steering controller 14 initiates diagnostic logic to detect one or more sensor faults during analysis of the raw sensor data from both pairs of angular position sensors 44, 46, linear speed sensor 58, optional lateral acceleration sensor 56, and RWA sensor 12. Lateral acceleration sensor 56 may be omitted as lateral acceleration can be estimated using other sensor measurements. Thus, vehicle steering controller 14 receives data concerning vehicle dynamics and determines if the sensors are functioning properly. If one or more sensor faults are detected, the vehicle steering controller 14 determines a safe state for the vehicle.

Examples of safe state may include bringing the vehicle to an immediate stop, revert to an alternate steering input system, or switching to a low speed ‘limp home’ mode. The nature of the safe state is usually determined by the vehicle integrator and depends on the functional safety risk analysis of the vehicle. In general, the safe state is selected to preclude injury to the operator by disabling the system with the indicated fault. Additionally, microcontroller 50 conducts a diagnostic check of sensor data provided by both pairs of angular position sensors 44, 46.

The provision of data to microcontroller 50 initiates the closed loop operation depicted in FIGS. 3A and 3B. During operation of either a land or marine vehicle with a steer-by-wire system, movement of steering shaft 18 (Box A) will result in a change in the angular position of magnet 26 as read by angular position sensors 44, 46 (Box B). Data from angular position sensors 44, 46 is reported to vehicle steering controller 14 (Box D) by microcontroller 50 via any convenient path such as CAN 52 or using electrical signals 62 like pulse width modulation or an analog voltage level via a separate connection (Box C). Using this input sensor data, vehicle steering controller 14 commands the vehicle steer-by-wire system to produce a change of vehicle wheel 10 orientation (ORWA). During this same time, vehicle steering controller 14 (Box D) receives a combination of one or more of linear speed and lateral acceleration data from the vehicle's original equipment sensors 12, 56, 58.

Data from vehicle steering controller 14 passes over CAN 52 to microcontroller 50 of FFD 20 (Box E). Microcontroller 50 (Box E) uses the data to calculate a Target Parameter and subsequently performs the scaling and saturation of the data in Box F as defined above and known to those skilled in the art, to improve the operation of microcontrollers 50. Note: each vehicle responds differently (based on weight, wheel configuration, steering ratio, turning actuation method, road conditions, etc.); therefore, accurate modeling of all vehicles and all conditions is not possible. However, the closed loop control strategy shown in FIGS. 3A and 3B provides the ability to handle all the vehicle types and various vehicle specific parameter variations while providing the desired performance.

As depicted in FIGS. 3A and 3B, the Target Parameter will be used as a feedback input to determine values necessary for the operation of electrically controlled motor 24 and enhance the safe control of the steer-by-wire system to command motor torque that will drive the Target Parameter value to zero. Microcontroller 50 manages operation of motor 24 in a manner to drive the Target Parameter value to zero, thereby manipulating steering shaft 18 to a defined center position. Additionally, damping of steering shaft 18 is achieved by microcontroller 50 operation of brake 22. This damping action slows motion of steering shaft 18 in order to minimize oscillation above and below the Target Parameter. In other words, operation of brake 22 produces a resistance to a change in the angular position of steering shaft 18. In this manner, FFD 20 replicates the return-to-center operation of traditional mechanical systems.

With reference to FIG. 3, microcontroller 50 performs all steps of Boxes H, I, J and K of the controlled feedback portion of the closed loop operation depicted in Primary Box G. Microcontroller 50 is programmed with a suitable closed loop feedback control scheme such as, but not limited to, proportional control (P), proportional integral (PI), or proportional-integral-derivative (PID). The initial output of the closed loop feedback is the desired motor torque, TCOMMAND. Microcontroller uses the determined value of TCOMMAND with the known value of motor torque constant (box I) to determine the current ICOMMAND necessary to manage the operation of motor drive amplifier 42 in control of motor 24. Using the values of ICOMMAND, microcontroller 50 applies the required current (Box K) to the windings of motor 24 to produce the motor torque TSTEER (box N) necessary to achieve the Target Parameter by rotating steering shaft 18 to the desired position. Microcontroller 50 constantly monitors and performs diagnostics on electrically controlled motor 24 (Box J) using data from motor current amplifiers 42 (box L) and motor current sensors (Box M). Finally, under the direction of microcontroller 50 motor current (Box K) passes to motor current amplifiers 42 (Box L) and is applied to electrically controlled motor 24 to achieve the desired feedback, i.e. applied torque to steering shaft 18, for safe operation of the steer-by-wire system.

Thus, microcontroller 50 utilizes vehicle steering controller 14 data i.e., RWA, lateral acceleration and linear speed, along with steering shaft angular position as measured by at least one of first and second pairs of angular position sensors 44, 46 to manage electric motor 24 and electric brake 22 to provide the torque necessary to return steering shaft 18 to the center position corresponding to the Target Parameter. Thus, FFD system 20 works in conjunction with vehicle steering controller 14 to simulate the mechanical operation provided by the alignment of the vehicles suspension (specifically the caster and toe-in values for traditional land vehicles).

FIGS. 4A and 4B provide a flowchart for the safety loop with operational control over electrically controlled motor 24. The process flow steps outlined in FIG. 4 precludes the un-commanded operation of motor drive amplifier 42 which may lead to un-commanded operation of electrically controlled motor 24. The process starts with the FFD microcontroller 50 or 50a reading vehicle information transmitted to it via CAN bus 52. Microcontroller 50 or 50a then calculates the desired motor torque required to rotate the shaft. The microcontroller then reads values from the angular position sensors 44, 46 and determines whether any sensor is faulted; if a persistent fault exists, then the microcontroller disables the motor drive circuit. If there are no sensor faults, the microcontroller then calculates the motor winding currents required for commutation and controls the motor drive amplifier circuit accordingly. Microcontroller then reads the motor current sensors and calculates the error between the commanded level and actual. If an error persists beyond pre-determined tolerance, a counter is incremented; else, the counter is reset to zero. If this error persistence counter exceeds a certain safety limit, the microcontroller disables the motor drive amplifier circuit and sets the appropriate motor current fault parameter. The preset safety limit will correspond generally to the response time of the human operator or the vehicle steering controller 14 response time. If motor current following error counter value is less than allowable safe limit, then the motor drive circuit stays enabled. One effect of disabling the motor drive circuit is to set the command current level to zero. This software action provides one approach for disabling the drive circuit.

Finally, the microcontroller includes the motor current fault parameter within the CAN message and transmits on CAN bus 52. As depicted in FIGS. 4A and 4B, during operation of the electrically controlled motor 24, microcontroller 50 monitors electrical current to and from motor drive amplifier 42. If the current applied to electrically controlled motor 24 falls outside of predetermined specifications for predetermined time duration as programmed into microcontroller 50, then microcontroller 50 will disable motor drive amplifier 42. Thus, microcontroller 50 prevents un-commanded motor operation condition which may result from failure of the motor drive amplifier 42.

FIGS. 5A and 5B provide a flowchart for the safety loop with operational control over electrically controlled brake 22. The process flow steps outlined in FIGS. 5A and 5B preclude the un-commanded operation of brake drive electronics 38 which may lead to excessive torque or a locked steering shaft 18 condition. The process starts with the FFD microcontroller 50 or 50a reading vehicle information transmitted to it via CAN bus 52. The microcontroller then reads values from the angular position sensors 44, 46 and determines whether any sensor is faulted; if a persistent fault exists, then the microcontroller disables the brake drive circuit. Upon a determination of no sensor faults, the microcontroller uses the angular sensor values to calculate steering position and speed followed by computation of the current required to generate brake feel. Microcontroller then commands current through the brake coil. Microcontroller then reads the actual current in the brake coil using the brake current sensors and calculates the following error between commanded current level and actual sensed current level. If an error persists beyond pre-determined tolerance, a counter is incremented. When no error remains, the counter is reset to zero. If this error persistence counter exceeds a certain safety limit, the microcontroller disables the brake drive amplifier circuit and sets the appropriate brake current fault parameter. If brake current following error counter value is less than allowable safe limit, then the brake drive circuit stays enabled. One effect of disabling the brake drive circuit is to set the command brake current level to zero. Finally, the microcontroller includes the brake current fault parameter within the CAN message and transmits on CAN bus 52.

During performance of the closed loop operation depicted in FIGS. 3A and 3B, vehicle steering controller 14 and microcontroller 50 also continuously conduct diagnostic checks of first angular position sensors 44 and optionally in some embodiments may perform diagnostic checks of angular position sensors 46, brake drive amplifier 38 and motor drive amplifier 42. In the exemplary embodiment of FIGS. 1 and 2, vehicle steering controller 14 has primary responsibility for monitoring conventional onboard sensors such as linear and lateral speed sensors, not shown, and first and second pairs of angular position sensors 44, 46. Data from these sensors is transmitted to vehicle steering controller 14 as discussed above. Microcontroller 50 upon detecting persistent fault in one or more of the angular position sensors 44, 46 shall disable the motor drive amplifier 42 and disable the brake drive amplifier 38. Thus, FIGS. 4A and 4B provide safety loop operational control over electrically controlled motor 24 while FIGS. 5A and 5B provide safety loop operational control over electrically controlled brake 22.

In addition to the monitoring of the indicated sensors by vehicle steering controller 14, microcontroller 50 monitors electrical current to and from brake drive amplifier 38. If the current applied to electrically controlled brake 22 falls outside of predetermined specifications for a predetermined time duration as programmed into microcontroller 50, then microcontroller 50 will shut down brake drive amplifier 38. Thus, microcontroller 50 precludes a locked steering condition which may result from failure of the brake drive amplifier 38.

FIG. 7 provides a second exemplary embodiment of a block diagram of the elements of FFD 20. This exemplary embodiment differs from the embodiment depicted in FIG. 2 in that the angular positions measured by the sensors 44, 46 are read by the FFD microcontrollers 50a, 50b and then transmitted to the vehicle steering controller 14 over the CAN bus 52. In this embodiment, there is no direct electrical communication between angular sensors 44, 46 and vehicle steering controller 14. Additionally, sensor diagnostics for both pairs of angular position sensors 44, 46 are initially performed by microcontroller 50a and microcontroller 50b and provided over CAN 52 to vehicle steering controller 14. Microcontrollers 50a and 50b communicate digitally with each other over an electrically isolated interface 54 and transfer data related to angular positions sensors 44, 46, motor current control (ICOMMAND, FIG. 3b), and brake current control (ICOMMAND-Brake, FIG. 8). In the embodiment of FIGS. 6 and 7, only two power inputs 32 and 34 are required. Input 32 provides power to main microcontroller 50a, first pair of angular position sensors 44, brake drive amplifier 38 and motor drive amplifier 42. Input 34 provides power to safety microcontroller 50b and second pair of angular position sensors 46. Safety microcontroller 50b is also in communication with vehicle steering controller 14 and provides redundancy sufficient to permit operation of a “limp home” mode in the event of a failure of main microcontroller 50a. Main microcontroller 50a has primary control over operation of the brake drive amplifier 38 and motor drive circuitry 42 and can shut down both in case of persistent faults detected per flowcharts in FIGS. 4 and 5. Safety microcontroller 50b monitors the state of the brake drive amplifier 38 and motor drive circuitry 42 and can independently shut down both in case of detected persistent faults. Operation of the exemplary embodiment of FIGS. 6 and 7 utilizes the same programming set forth in the process flow diagrams of FIGS. 3-5 as used by the exemplary embodiment of FIGS. 1 and 2.

FIG. 8 depicts the closed loop operation of the tactile feel generated by the electrically actuated brake 22. Tactile feel is based on operator feedback desired and can include features like end-stop, mid-range velocity dependent braking, or warning vibration. The braking torque, TBRAKE, generated by the electrically actuated brake 22 (box A) acts upon the steering system (box B) and provides tactile feedback or braking resistance to the operator of the steering wheel 16. The resulting steering motion (θSTEER) is read by the angular position sensors 44, 46 (box C) and used by the main microcontroller 50 or 50a to calculate brake current command ICOMMAND-Brake (box D) for desired brake feel. Microcontroller 50 or 50a then calculates the necessary PWM amplifier duty cycle (box F) using this command along with the brake coil current IBRAKE measured by brake current sensors (box I). The brake drive amplifier (box H) drives current through the brake 22 to perform brake operation (box A). Microcontroller 50, 50a, 50b also implement coil sensor monitoring and angular position sensor monitoring (box G) and can shut down the brake current amplifier in case of a detected fault.

Other embodiments of the present invention will be apparent to one skilled in the art. As such, the foregoing description merely enables and describes the general uses and methods of the present invention. Accordingly, the following claims define the true scope of the present invention.

What is claimed is:

1. A force feedback system comprising:
a steering shaft 18;
a Hall sensor magnet 26 carried by the steering shaft;
an electrically controlled brake 22 configured to engage the steering shaft;
an electronically controlled motor 24 configured to engage the steering shaft;
at least one electrical power source 32;
a brake drive amplifier 38, the brake drive amplifier receives electrical power from the at least one electrical power source and the brake drive amplifier provides electrical current to the electronically controlled brake;
motor drive amplifier 42, the motor drive amplifier receives electrical power from the at least one electrical power source and the motor drive amplifier provides electrical current to the electronically controlled motor;
a first pair of angular position sensors 44, the first pair of angular position sensors receive electrical power from the at least one electrical power source;
a vehicle controller 14, the vehicle controller in data communication with the first pair of angular position sensors.

2. The force feedback system of claim 1, wherein the first pair of angular position sensors is positioned to monitor radial changes in the Hall sensor magnet.

3. The force feedback system of claim 1, further comprising a second pair of angular position sensors, the second pair of angular position sensors receive electrical power from the at least one electrical power source; and,
the first and second pairs of angular position sensors are positioned to monitor radial changes in the Hall sensor magnet.

4. The force feedback system of claim 1, further comprising a microcontroller 50, microcontroller 50 is in data communication with the vehicle controller, the first pair of angular position sensors, the brake drive amplifier and the motor drive amplifier and the microcontroller receives electrical power from the at least one electrical power source.

5. The force feedback system of claim 4, wherein the microcontroller is programed to receive vehicle data over a digital communication bus and to control the electronically controlled motor and the electronically controlled brake in response to the received vehicle data.

6. The force feedback system of claim 4, further comprising a second electrical power source, wherein in the force feedback system the first electrical power source provide electrical power to the microcontroller, the brake drive amplifier and the motor drive amplifier and the second electrical power source provides electrical power to the first and second pairs of angular position sensors.

7. The force feedback system of claim 4, further comprising a second electrical power source and a third electrical power source, wherein in the force feedback system the first electrical power source provide electrical power to the microcontroller, the brake drive amplifier and the motor drive amplifier, the second electrical power source provides electrical power to the first pair of angular position sensors and the third electrical power source provides electrical power to the second pair of angular position sensors.

8. A force feedback system comprising:
a steering shaft 18;
a Hall sensor magnet 26 carried by the steering shaft;
an electrically controlled brake 22 configured to engage the steering shaft;
an electronically controlled motor 24 configured to engage the steering shaft;
a first electrical power source 32;
a second electrical power source 34;
a third electrical power source 36;
a brake drive amplifier 38, the brake drive amplifier receives electrical power from the first one electrical power source and the brake drive amplifier provides electrical current to the electronically controlled brake;
motor drive amplifier 42, the motor drive amplifier receives electrical power from the first electrical power source and the motor drive amplifier provides electrical current to the electronically controlled motor;
a first pair of angular position sensors 44, the first pair of angular position sensors receive electrical power from the at least one electrical power source, the first pair of angular position sensors receive electrical power from the second electrical power source;
a second pair of angular position sensors 46, the second pair of angular position sensors receive electrical power from the at least one electrical power source the second pair of angular position sensors receive electrical power from the third electrical power source;
a vehicle controller 14, the vehicle controller in data communication with the first and second pairs of angular position sensors.

9. The force feedback system of claim 8, wherein the first and second pairs of angular position sensors are positioned to monitor radial changes in the Hall sensor magnet.

10. The force feedback system of claim 8, further comprising a microcontroller 50, microcontroller 50 is in data communication with the vehicle controller, the first pair of angular position sensors, the brake drive amplifier and the motor drive amplifier and the microcontroller receives electrical power from the at least one electrical power source.

11. The force feedback system of claim 10, wherein the microcontroller is programed to receive vehicle data over a digital communication bus and to control the electronically controlled motor and the electronically controlled brake in response to the received vehicle data.

12. A force feedback system comprising:
a steering shaft 18;
a Hall sensor magnet 26 carried by the steering shaft;
an electrically controlled brake 22 configured to engage the steering shaft;
an electronically controlled motor 24 configured to engage the steering shaft, a first electrical power source 32;
a brake drive amplifier 38, the brake drive amplifier receives electrical power from the first electrical power source and the brake drive amplifier provides electrical current to the electronically controlled brake;
motor drive amplifier 42, the motor drive amplifier receives electrical power from the first electrical power source and the motor drive amplifier provides electrical current to the electronically controlled motor;
a first pair of angular position sensors 44, the first pair of angular position sensors receive electrical power from the at first electrical power source;
a vehicle controller 14: and, a main microcontroller 50a and a safety microcontroller 50b.

13. The force feedback system of claim 12, further comprising a vehicle steering controller 14, the vehicle steering controller is in data communication with main microcontroller and safety microcontroller, the main microcontroller receives data communication from the brake drive amplifier, the motor drive amplifier and the first pair of angular position sensors, wherein the vehicle steering controller is not in direct electrical communication with the first pair of angular position sensors.

14. The force feedback system of claim 12, wherein the first pair of angular position sensors is positioned to monitor radial changes in the Hall sensor magnet.

15. The force feedback system of claim 12, further comprising a second pair of angular position sensors, the second pair of angular position sensors receive electrical power from the at least one electrical power source; and,
the first and second pairs of angular position sensors are positioned to monitor radial changes in the Hall sensor magnet.

16. The force feedback system of claim 12, wherein the main microcontroller is programed to control the electronically controlled motor and the electronically controlled brake in response to vehicle data received from the vehicle controller and in response to data received from the first pair of angular position sensors and the second pair of angular position sensors.

17. The force feedback system of claim 12, further comprising a second electrical power source;
wherein the first electrical power source provides electrical power to the main microcontroller, the brake drive amplifier, the motor drive amplifier and the first pair of angular position sensors; and,
wherein the second electrical power source provides electrical power to a second pair of angular position sensors and the safety microcontroller.

18. The force feedback system of claim 12, wherein the safety microcontroller is in data communication with the main microcontroller, the brake drive amplifier, the motor drive amplifier, the vehicle controller, the first pair of angular position sensors and the second pair of angular position sensors.

19. The force feedback system of claim 12, wherein, in the event of a failure of the main microcontroller, the safety microcontroller is programmed to disable the electronically controlled motor and to disable the electronically controlled brake.

20. A method for returning a steering control system of a vehicle to a center position comprising:
the vehicle having at least one steering wheel, the steering wheel capable of adjusting the steering control system through a range of angular orientations including the center position of the steering control system;
the steering control system including an electric motor 24 and a steering input controller 21, the steering input controller directly or indirectly controls the angle of the wheel by controlling operation of the electric motor,
the steering control system including a force feedback device 20, the force feedback device in data communication with the vehicle steering controller, the force feedback device including at least one angular position sensor 44, an electric motor 24, an electrically actuated brake and a microcontroller 50;
transmitting data provided by the at least one angular position sensor to the vehicle controller;
transmitting data from the road wheel angle sensor, the vehicle speed sensor, to the vehicle controller;
the vehicle controller analyzing the data received to detect a fault in any one of the at least one angular position sensor;
the microcontroller initiating a closed loop operation to produce a change in the angular orientation of the wheel;
the microcontroller defining a value for a Target Parameter using data received by the microcontroller wherein a value of zero corresponds to the center position of the steering control of the vehicle;
the microcontroller managing the operation of the force feedback system to drive the Target Parameter to a value of zero by controlling the operation of the electric motor.

21. The method of claim 20, wherein the force feedback system further comprises a steering shaft connected to the steering wheel, the steering shaft operationally connected to the electric motor and operationally connected to an electric brake, the operation of the electric brake managed by the microcontroller, and further comprising the steps of:
the microcontroller calculating a torque value to be imparted by the electric motor to the steering shaft; and,
the microcontroller controlling operation of the electric brake in order to apply resistance to changes in an angular position of the steering shaft.

22. The method of claim 21, wherein the force feedback system further comprises a motor drive amplifier and further comprising the steps of:
the microcontroller programmed with an acceptable current range for operation of the electric motor, the microcontroller monitoring the electric current applied to the electric motor;
the microcontroller disabling the motor drive amplifier if the electric current applied to the electric motor falls outside of the acceptable current range for a pre-determined persistence duration;
the microcontroller transmitting motor fault information to the vehicle controller over the digital communication bus.

23. The method of claim 21, wherein the force feedback system further comprises a brake drive amplifier and further comprising the steps of:
the microcontroller programmed with an acceptable current range for operation of the electric brake, the microcontroller monitoring the electric current applied to the electric brake;
the microcontroller disabling the brake drive amplifier if the electric current applied to the electric brake falls outside of the acceptable current range for a pre-determined persistence duration;
the microcontroller transmitting motor fault information to the vehicle controller over the digital communication bus.

24. The method of claim 21, further comprising the step of:
disabling the electric motor and the electric brake upon detection of a fault in any one of the at least one angular position sensor.

25. The method of claim 24, further comprising the step of:
transmitting sensor fault information to the vehicle controller over the digital communication bus.
